(19) United States
(12) Patent Application Publication
(10) Pub. No.: US 2026/0042706 A1
(43) Pub. Date: Feb. 12, 2026

(54) METHOD FOR MANUFACTURING ECO-FRIENDLY CONCRETE USING RESPONSE SURFACE METHODOLOGY

(71) Applicant: EcoRemix Co., Ltd., Incheon (KR)

(72) Inventor: Ho Jae SONG, Seoul (KR)

(21) Appl. No.: 19/292,035

(22) Filed: Aug. 6, 2025

(30) Foreign Application Priority Data
Aug. 6, 2024 (KR) 10-2024-0104631
Aug. 5, 2025 (KR) 10-2025-0107282

(51) Int. Cl. C04B 14/36; C04B 18/167; C04B 111/00

(52) U.S. Cl. CPC C04B 14/361; C04B 18/167; C04B 2111/00017

(57) ABSTRACT

According to one embodiment of the present disclosure, a method for manufacturing eco-friendly concrete using a response surface methodology (RSM) is provided, the method comprising: a step (S1) of determining a plurality of experimental factors to be considered in manufacturing the eco-friendly concrete; and a step (S2) of deriving optimal mix proportions of the eco-friendly concrete using a Box-Behnken Design based on the experimental factors.

### CROSS-REFERENCE TO RELATED APPLICATIONS

This application claims priority to Korean Patent Applications No. 10-2025-0107282 filed on Aug. 5, 2025, and No. 10-2024-0104631 filed on Aug. 6, 2024, and all the benefits accruing therefrom under 35 U.S.C. § 119, the contents of which are incorporated by reference in their entirety.

### BACKGROUND

As the demand for green buildings has recently increased, the global market for eco-friendly construction materials and recycled concrete aggregates (RCA), which enable the reduction of greenhouse gas emissions and the use of recycled aggregates, is rapidly growing. Specifically, the eco-friendly concrete market is expected to grow from approximately 54 trillion KRW in 2024 to about 115 trillion KRW by 2032, and the recycled concrete aggregate market is expected to grow from approximately 12 trillion KRW in 2023 to about 27 trillion KRW by 2033.

In addition, public procurement policies both domestically and internationally are increasingly mandating the purchase of eco-friendly materials. In particular, in Korea, the demand for eco-friendly construction materials is rapidly increasing in accordance with the “Mandatory Purchase System for Green Products by Public Institutions.”

However, despite this market growth, the actual recycling rate of construction waste in Korea remains at only about 5.1%. This is due to quality variation in recycled aggregates and soil, low reliability, and limited usage, and although a quality certification system for recycled aggregates exists, there is a gap between the actual operating environment of factories and the certification environment, resulting in low institutional effectiveness.

The issue of insufficient actual recycling of construction waste poses a significant crisis to both the construction industry and the construction waste industry, due to: (1) the continuous increase in the price of natural aggregates caused by environmental destruction and resource depletion; and (2) the increased disposal cost of unrecycled aggregates, which burdens the operating cost of construction waste disposal companies.

Accordingly, research and development on methods for increasing the actual recycling of construction waste and for manufacturing eco-friendly concrete with excellent quality is required.

### SUMMARY

One aspect of the present disclosure is to provide a method for manufacturing eco-friendly concrete capable of increasing the actual recycling of construction waste.

Another aspect of the present disclosure is to provide a method for consistently producing eco-friendly concrete of excellent quality by resolving quality variation.

Another aspect of the present disclosure is to address the issue of depletion of natural aggregate resources and to reduce the production cost of concrete.

A method for manufacturing eco-friendly concrete according to one embodiment of the present disclosure is a method using a response surface methodology (RSM), and includes: a step (S1) of determining a plurality of experimental factors to be considered in the manufacture of the eco-friendly concrete; and a step (S2) of deriving optimal mix proportions of the eco-friendly concrete using a Box-Behnken Design based on the experimental factors.

In some embodiments, the eco-friendly concrete may include at least one of recycled aggregates and recycled soil.

In some embodiments, the experimental factors may include at least three selected from the group consisting of: the type of cement, the content of cement, the composition of the recycled aggregates, the grade of the recycled aggregates, the content of the recycled aggregates, the composition of the recycled soil, the grade of the recycled soil, the content of the recycled soil, the content of foreign substances, the type of admixture, the content of admixture, the type of additional binder, the content of additional binder, the water-to-cement ratio, slump value, mixer capacity, curing method, curing time, curing conditions, and the specifications of the concrete product.

In some embodiments, the experimental factors may include at least one of the grade of the recycled aggregates and the grade of the recycled soil, and the grades of the recycled aggregates and the recycled soil may be classified into three grades according to the respective quality.

In some embodiments, the quality evaluation items may include at least one selected from the group consisting of: absorption ratio, sludge content, moisture content, abrasion ratio, chloride content, density, and organic impurity content.

In some embodiments, the step (S2) of deriving the optimal mix proportions of the eco-friendly concrete may include: a step (S2-1) of designing a Box-Behnken matrix using the experimental factors as variables; a step (S2-2) of obtaining experimental values of the eco-friendly concrete according to an experimental plan designed in the Box-Behnken matrix; a step (S2-3) of deriving a second-order regression model using the experimental values; a step (S2-4) of verifying the reliability of the second-order regression model; a step (S2-5) of deriving a 3D response surface plot using the second-order regression model; and a step (S2-6) of deriving the optimal mix proportions of the eco-friendly concrete using the 3D response surface plot.

The eco-friendly concrete according to one embodiment of the present disclosure is manufactured by the manufacturing method according to any one of the above-described embodiments.

According to one embodiment of the present disclosure, it is possible to improve the actual recycling of construction waste by manufacturing eco-friendly concrete with a high replacement rate of recycled aggregates and soil.

According to another embodiment of the present disclosure, it is possible to manufacture eco-friendly concrete with excellent performance, such as compressive strength, with uniform quality.

According to another embodiment of the present disclosure, it is possible to address the issue of depletion of natural aggregate resources and simultaneously achieve both environmental and economic effects, such as reduction in production costs and enhancement of market competitiveness, through the manufacture of high-quality concrete using construction waste.

### DETAILED DESCRIPTION OF EMBODIMENTS

In the present specification, unless clearly stated otherwise in the context, expressions in the singular include the plural.

In the present specification, the terms “comprise” and/or “comprising” specify the presence of stated shapes, steps, numbers, actions, members, elements and/or groups thereof, but do not preclude the presence or addition of one or more other shapes, steps, numbers, actions, members, elements and/or groups thereof.

In the present specification, the expression “at least one of a, b, and c” means that a, b, or c may be included individually, or any combination of two or more selected from the group consisting of a, b, and c may be included.

As used in the present specification, the term “connected” includes not only direct connection between members, but also indirect connection in which other members are interposed therebetween.

When multiple embodiments are described in the present specification, unless otherwise stated to the contrary, the respective embodiments may be combined with each other. In this case, the effects of the present invention may include not only the effects derived from each embodiment, but also the effects arising from the organic combination of the respective embodiments. For example, even if Embodiment 1 and Embodiment 2 are described independently in the present specification, unless clearly stated otherwise in the context, Embodiment 1 and Embodiment 2 may be organically combined with each other, and the effects of the present invention may include the effects arising from the combination of Embodiments 1 and 2.

In the present specification, a numerical range expressed using the term “to” indicates a range that includes both the lower and upper limits specified before and after the term, respectively.

When multiple values are disclosed as the upper or lower limit of any numerical range, the numerical ranges disclosed in the present specification are to be understood as including all possible ranges formed by selecting any one value from the multiple lower limits and any one value from the multiple upper limits. For example, when “a to b” or “c to d” is described in the specification, it shall be understood as including ranges such as: from a to b, from a to d, from c to d, or from c to b.

As used in the present specification, the terms “about” or “substantially” refer to reasonable variations that do not materially alter the final result. These terms may be interpreted to include deviations of at least±5% or at least±10%, to the extent that such deviations do not negate the intended meaning of the terms.

In the present specification, the term “Response Surface Methodology (RSM)” refers to an experimental optimization technique that identifies critical experimental factors affecting a response value and then analyzes the optimal response value using a small number of those important factors.

Hereinafter, a method for manufacturing eco-friendly concrete according to embodiments of the present disclosure will be described in detail.

### Method for Manufacturing Eco-Friendly Concrete

A method for manufacturing eco-friendly concrete according to one embodiment of the present disclosure is a method utilizing a response surface methodology (RSM), and includes: a step (S1) of determining a plurality of experimental factors to be considered in the manufacture of eco-friendly concrete; and a step (S2) of deriving the optimal mix proportions of the eco-friendly concrete using a Box-Behnken Design based on the experimental factors.

In the traditional One Factor At a Time (OFAT) method, in which one of multiple factors is varied independently in each experiment, it is difficult to identify the optimal experimental conditions. The OFAT method cannot account for interactions among important factors in complex processes, and it is limited in its ability to evaluate the entire experimental region in a balanced manner. Therefore, it often leads to identifying only local optimal points.

On the other hand, the Response Surface Methodology (RSM) is a system for finding optimal conditions using multiple variables, which allows for identifying the optimal values of variables by measuring the effects caused by interactions between one variable and other variables. Specifically, the RSM is an experimental design technique (Design of Experiments; DOE) that enables the acquisition of maximum information from a minimum number of experimental trials. By analyzing the experimental data obtained through such DOE, it is possible to understand the performance of complex systems, identify significant factor effects influencing the response variable, and perform optimization.

The DOE may include Full-Factorial Design, Central Composite Design, and Box-Behnken Design, among others. A comparison of the characteristics of these methods is shown in Table 1 below.

TABLE 1

| | Comparison of Experimental Design Methods (DOE) | | |
|---|---|---|---|
| Classification | Full-Factorial | Central Composite | Box-Behnken |
| Number of | More than | 40 times | 27 times |
| Experiments (4 | 200 times | | |
| variables) | | | |
| Condition | Not possible | Partially | Possible |
| Variation | | possible | |
| Response | Not possible | Second-order | Second-order |
| Prediction | | regression model | regression model |
| Result | Low | High | High |
| Reliability | | | |

The Box-Behnken Design is an experimental design method that models the curvature of responses according to the variation of specific significant factors, thereby allowing the derivation of optimal setting values. As shown in Table 1, the Box-Behnken Design enables obtaining highly reliable results with a minimal number of experiments.

In a method for manufacturing eco-friendly concrete according to one embodiment of the present disclosure, the experimental design is carried out using the Box-Behnken Design, which is a type of Response Surface Methodology (RSM). Accordingly, even with a small number of experimental trials, it is possible to derive the optimal mix proportions of the eco-friendly concrete with high reliability. Hereinafter, the step (S1) of determining a plurality of experimental factors to be considered in the manufacture of the eco-friendly concrete will be described in detail.

### Step of Determining Experimental Factors

The method for manufacturing eco-friendly concrete employs a Response Surface Methodology (RSM), which is a statistical technique for obtaining an optimal solution through a full second-order regression model based on the relationship between multiple experimental factors and responses within the experimental range. The method includes a step (S1) of determining a plurality of experimental factors to be considered in the manufacture of the eco-friendly concrete.

Specifically, the method involves selecting three or more experimental factors among specific variables-such as mix proportions and slump value-which determine the performance (response value) of the concrete product. Based on the derived optimal mix proportions from these experimental factors, the eco-friendly concrete may then be manufactured.

In some embodiments, the experimental factors may include at least three selected from the group consisting of: the type of cement, the content of cement, the composition of recycled aggregate, the grade of recycled aggregate, the content of recycled aggregate, the composition of recycled soil, the grade of recycled soil, the content of recycled soil, the content of foreign substances, the type of admixture, the content of admixture, the type of additional binder, the content of additional binder, water-to-cement ratio, slump value, mixer capacity, curing method, curing time, curing conditions, and the specifications of the concrete product.

For example, the type of cement may be classified into three types: Ordinary Portland Cement (OPC), Fly Ash Concrete, and blended cement.

For example, the content of the cement may be applied in five stages ranging from 10 wt % to 30 wt %, such as 10 wt %, 15 wt %, 20 wt %, 25 wt %, or 30 wt %.

The composition of the recycled aggregate may be based on, for example, the ratio of coarse aggregate to fine aggregate.

The grade and content of the recycled aggregate may be classified, for example, into three grades: high, medium, and low; and the input amount may be applied based on the grade, for example, in seven stages ranging from 20 wt % to 80 wt %, such as 20 wt %, 30 wt %, 40 wt %, 50 wt %, 60 wt %, 70 wt %, or 80 wt %.

The composition of the recycled soil may be based on, for example, the ratio of sand/silt/clay and the soil content (in wt %).

The grade and content of the recycled soil may be classified, for example, into three grades: high, medium, and low; and the input amount may be applied based on the grade, for example, in seven stages ranging from 20 wt % to 80 wt %, such as 20 wt %, 30 wt %, 40 wt %, 50 wt %, 60 wt %, 70 wt %, or 80 wt %.

The content of foreign substances refers to the amount of impurities such as paper or metal included in the concrete, and may be applied, for example, in three stages ranging from 1 wt % to 10 wt %, such as 1 wt %, 5 wt %, or 10 wt %.

The type and content of the admixture may be, for example, four types: air-entraining (AE) water-reducing agent, retarder, accelerator, and foaming agent; and the content may be applied in three stages ranging from 1 wt % to 10 wt %, such as 1 wt %, 5 wt %, or 10 wt %.

The type and content of the additional binder may be, for example, four types: fly ash (FA), ground granulated blast-furnace slag (GGBFS), silica fume, and air-entraining agent (AE); and the content may be applied in three stages ranging from 1 wt % to 10 wt %, such as 1 wt %, 5 wt %, or 10 wt %.

The water-to-cement ratio (W/C) may be calculated as the weight of water divided by the weight of cement in the concrete mix. In general, the lower the value, the greater the strength of the concrete, but the reactivity and workability may decrease. For example, the water-to-cement ratio may be applied in four stages, such as 0.30, 0.35, 0.40, or 0.45.

The slump value may be applied, for example, in four stages ranging from 0 cm to 15 cm, such as 0 cm, 5 cm, 10 cm, or 15 cm, and may be measured in accordance with KS F 2402.

The mixer capacity may be based on volume in cubic meters (m³), and may be applied, for example, in five stages ranging from 1 m³ to 20 m³, such as 1 m³, 5 m³, 10 m³, 15 m³, or 20 m³.

The curing method may be applied, for example, by classifying into two types: wet curing and dry curing.

The curing time may be applied, for example, in three stages such as 14 days, 28 days, or 42 days.

The curing conditions may be applied, for example, based on humidity (e.g., whether relative humidity exceeds 80%) and/or temperature (e.g., whether between 20° C. and 30° C.).

The specifications of the concrete product may be applied, for example, based on the shape and size of concrete blocks in accordance with KS or ISO standards.

In some embodiments, the experimental factors may include at least one of the grade of recycled aggregate and the grade of recycled soil, and the grades of the recycled aggregate and recycled soil may each be classified into three levels according to their respective quality.

Even when the same mix proportions are applied, the quality of recycled aggregates and recycled soil may vary significantly. Due to such large quality variations, the recycling of recycled aggregates and recycled soil has been avoided, and it may be necessary to classify them into grades according to intended use, such as structural use (Class A), non-structural use (Class B), and simple filler use (Class C).

Accordingly, in the manufacture of eco-friendly concrete, if the grade of recycled aggregate and/or recycled soil is considered as an experimental factor, and such grades are classified not by arbitrary numerical values but by specific criteria and quantitative indicators that reflect actual quality, and if appropriate mix proportions are derived based on the respective quality levels, it becomes possible to manufacture eco-friendly concrete with excellent performance and minimal quality variation.

In some embodiments, the quality evaluation items may include at least one selected from the group consisting of: absorption ratio, sludge content, moisture content, abrasion ratio, chloride content, density, and organic impurity content.

Specifically, the grades of the recycled aggregate and recycled soil may each be classified into three grades-Class A, Class B, and Class C-according to the quality classification tables shown in Tables 2 and 3 below, respectively.

TABLE 2

| | Grade Classification Table According | | | |
|---|---|---|---|---|
| | to the Quality of Recycled | | | |
| | Class | Class | Class | |
| Item | A | B | C | Remarks |
| Absorption | ≤3.0 | ≤5.0 | ≤7.0 | Based on KS F 2527: |
| ratio (wt %) | | | | natural gravel standard |
| Sludge content | ≤0.5 | ≤1.5 | ≤3.0 | May interfere with |
| (wt %) | | | | cement reaction |
| Abrasion ratio | ≤35 | ≤45 | ≤50 | Based on KS F 2508: |
| (wt %) | | | | may be restricted for |
| | | | | structural use |
| Chloride content | ≤0.03 | ≤0.05 | ≤0.10 | Based on KS F 4009, |
| (wt %) | | | | ISO 24684: risk of |
| | | | | rebar corrosion |
| Density (g/cm³) | ≥2.4 | ≥2.3 | ≥2.2 | Based on KS F 2503: |
| | | | | affects volumetric |
| | | | | mix design |
| Organic impurity | None | Slight | High | Based on KS F 2576: |
| content | | | | may be evaluated |
| | | | | using simplified |

As shown in Table 2, the grades of the recycled aggregate according to quality may be classified into three levels-Class A, Class B, and Class C-based on the numerical values or levels of absorption ratio, sludge content, abrasion ratio, chloride content, density, and organic impurity content.

For example, according to KS F 2527 (standard for natural gravel), if the absorption ratio of the recycled aggregate is 3.0 wt % or less, it may be classified as Class A; if greater than 3.0 wt % and not more than 5.0 wt %, as Class B; and if greater than 5.0 wt % and not more than 7.0 wt %, as Class C.

If the sludge content of the recycled aggregate is 0.5 wt % or less, it may be classified as Class A; if greater than 0.5 wt % and not more than 1.5 wt %, as Class B; and if greater than 1.5 wt % and not more than 3.0 wt %, as Class C.

According to KS F 2508, if the abrasion ratio of the recycled aggregate is 35 wt % or less, it may be classified as Class A; if greater than 35 wt % and not more than 45 wt %, as Class B; and if greater than 45 wt % and not more than 50 wt %, as Class C.

According to KS F 4009 or ISO 24684, for the evaluation of rebar corrosion, if the chloride content of the recycled aggregate is 0.03 wt % or less, it may be classified as Class A; if greater than 0.03 wt % and not more than 0.05 wt %, as Class B; and if greater than 0.05 wt % and not more than 0.10 wt %, as Class C.

According to KS F 2503, if the density of the recycled aggregate is 2.4 g/cm³ or more, it may be classified as Class A; if 2.3 g/cm³ or more and less than 2.4 g/cm³, as Class B; and if 2.2 g/cm³ or more and less than 2.3 g/cm³, as Class C.

According to KS F 2576, when a simplified specific gravity test is used, if the organic impurity content of the recycled aggregate is 0.5 wt % or less, it may be classified as Class A; if greater than 0.5 wt % and not more than 1.0 wt %, as Class B; and if greater than 1.0 wt % and not more than 1.5 wt %, as Class C.

The grade of the recycled aggregate may be determined based on a single quality evaluation item selected for classification, or based on a combination of two or more quality items, provided that the aggregate satisfies all corresponding criteria.

For example, if only one quality item-such as absorption ratio—is selected for classification, and the absorption ratio of the recycled aggregate is 3.0 wt % or less, the aggregate may be classified as Class A. In contrast, if two items-such as absorption ratio and abrasion ratio—are selected, and both the absorption ratio is 3.0 wt % or less and the abrasion ratio is 35 wt % or less, the recycled aggregate may be classified as Class A.

TABLE 3

| | Grade Classification Table According | | | |
|---|---|---|---|---|
| | to the Quality of Recycled Soil | | | |
| Item | Class A | Class B | Class C | Remarks |
| Absorption ratio | ≤1.5 | ≤2.5 | ≤4.0 | KS F 2504: affects |
| (wt %) | | | | water-to-cement ratio |
| Moisture content | ≤3.0 | ≤5.0 | ≤8.0 | Easier storage at |
| (wt %) | | | | appropriate moisture |
| | | | | content |
| Sludge content | ≤0.5 | ≤1.5 | ≤3.0 | May reduce reactivity |
| (wt %) | | | | during mixing |
| Chloride content | ≤0.03 | ≤0.05 | ≤0.10 | ISO 24684: risk of |
| (wt %) | | | | rebar corrosion |
| Density (g/cm³) | ≥2.3 | ≥2.2 | ≥2.0 | KS F 2504: affects mix |
| | | | | proportion calculation |
| Organic impurity | None | Slight | High | KS F 2576: may affect |
| content | | | | slump in wet mixing |

As shown in Table 3, the grades of the recycled soil according to quality may be classified into three levels-Class A, Class B, and Class C-based on the numerical values or levels of absorption ratio, moisture content, sludge content, chloride content, density, and organic impurity content.

According to KS F 2504, if the absorption ratio of the recycled soil is 1.5 wt % or less, it may be classified as Class A; if greater than 1.5 wt % and not more than 2.5 wt %, as Class B; and if greater than 2.5 wt % and not more than 4.0 wt %, as Class C.

If the moisture content of the recycled soil is 3.0 wt % or less, it may be classified as Class A; if greater than 3.0 wt % and not more than 5.0 wt %, as Class B; and if greater than 5.0 wt % and not more than 8.0 wt %, as Class C.

If the sludge content of the recycled soil is 0.5 wt % or less, it may be classified as Class A; if greater than 0.5 wt % and not more than 1.5 wt %, as Class B; and if greater than 1.5 wt % and not more than 3.0 wt %, as Class C.

According to ISO 24684, for the evaluation of rebar corrosion, if the chloride content of the recycled soil is 0.03 wt % or less, it may be classified as Class A; if greater than 0.03 wt % and not more than 0.05 wt %, as Class B; and if greater than 0.05 wt % and not more than 0.10 wt %, as Class C.

According to KS F 2504, if the density of the recycled soil is 2.3 g/cm³ or more, it may be classified as Class A; if 2.2 g/cm³ or more and less than 2.3 g/cm³, as Class B; and if 2.0 g/cm³ or more and less than 2.2 g/cm³, as Class C.

According to KS F 2576, if the organic impurity content of the recycled soil is 0.5 wt % or less, it may be classified as Class A; if greater than 0.5 wt % and not more than 1.0 wt %, as Class B; and if greater than 1.0 wt % and not more than 1.5 wt %, as Class C.

The grade of the recycled soil may be determined based on a single selected quality evaluation item, or based on a combination of two or more items, provided that all corresponding criteria are satisfied.

For example, if only one item-such as absorption ratio—is selected as the criterion, and the absorption ratio of the recycled soil is 1.5 wt % or less, the soil may be classified as Class A.

In contrast, if two items-such as absorption ratio and moisture content—are selected, and both the absorption ratio is 1.5 wt % or less and the moisture content is 3.0 wt % or less, the soil may be classified as Class A.

The above-described classification system for recycled aggregates and recycled soil is intended to establish a flexible quality control scheme that ensures performance while improving recyclability, rather than applying uniform standards used for natural materials.

Therefore, the classification into three grades-Class A to Class C—in Tables 2 and 3 is not for indicating superiority or inferiority in quality of the aggregates or soil, but rather for determining appropriate applications for each grade.

Hereinafter, the step (S2) of deriving the optimal mix proportions of the eco-friendly concrete will be described in detail.

### Step of Deriving Optimal Mix Proportions of Eco-Friendly Concrete

The method for manufacturing eco-friendly concrete includes a step (S2) of deriving the optimal mix proportions of the eco-friendly concrete using a Box-Behnken Design based on the plurality of experimental factors determined through the above-described step S1.

As previously described, the Box-Behnken Design enables highly reliable results to be obtained with a minimal number of experiments. In the present method, the experimental design is carried out using the Box-Behnken Design, which is a type of Response Surface Methodology (RSM), thereby allowing the optimal mix proportions of eco-friendly concrete to be derived with high reliability even from a small number of experiments.

In some embodiments, the step (S2) of deriving the optimal mix proportions of the eco-friendly concrete may include: a step (S2-1) of designing a Box-Behnken matrix using the experimental factors as variables; a step (S2-2) of obtaining experimental values of the eco-friendly concrete according to the experimental plan designed with the Box-Behnken matrix; a step (S2-3) of deriving a second-order regression model based on the experimental values; a step (S2-4) of verifying the reliability of the second-order regression model; a step (S2-5) of generating a 3D response surface plot using the second-order regression model; and a step (S2-6) of deriving the optimal mix proportions of the eco-friendly concrete using the 3D response surface plot.

Hereinafter, the steps S2-1 through S2-6 will be described in detail.

### <Step of Designing the Box-Behnken Matrix>

The step (S2-1) of designing the Box-Behnken matrix is a step of designing an experimental plan using the plurality of experimental factors determined in step S1 as variables, and may include performing stepwise coding for the experimental factors.

In this case, the coding may be carried out in three or more levels. For example, the coding may be carried out in three levels (−, 0, +) or five levels (−2,−1, 0, +1, +2).

For example, if four experimental factors-namely, cement content, foreign substance content, slump value, and curing time—are selected, each of the experimental factors may be coded into three levels of coded values: Low (−), Middle (0), and High (+), as shown in Table 4 below.

TABLE 4

| | Levels | | | |
|---|---|---|---|---|
| Experimental Factor | Xᵢ | Low (−) | Middle (0) | High (+) |
| Cement content (wt %) | X₁ | 10 | 20 | 30 |
| Foreign substance content | X₂ | 1 | 5 | 10 |
| (wt %) | | | | |
| Slump value (cm) | X₃ | 15 | 18 | 21 |
| Curing time (days) | X₄ | 14 | 28 | 42 |

Using the experimental factors and levels defined in Table 4, a total of 27 experiments corresponding to different conditions may be designed through the Box-Behnken Design, as shown in Table 5 below.

TABLE 5

| | | Cement | Foreign | Slump | |
|---|---|---|---|---|---|
| | | Content | Substance | Value | Curing Time |
| No | Pattern | (wt. %) | Content (wt. %) | (cm) | (days) |
| 1 | 0+−0 | 20 | 10 | 15 | 28 |
| 2 | ++00 | 30 | 10 | 18 | 28 |
| 3 | 0−0+ | 20 | 1 | 18 | 42 |
| 4 | +−00 | 30 | 1 | 18 | 28 |
| 5 | 0−+0 | 20 | 1 | 21 | 28 |
| 6 | 0−−0 | 20 | 1 | 15 | 28 |
| 7 | 0000 | 20 | 5 | 18 | 28 |
| 8 | −−00 | 10 | 1 | 18 | 28 |
| 9 | −0−0 | 10 | 5 | 15 | 28 |
| 10 | +0+0 | 30 | 5 | 21 | 28 |
| 11 | −00− | 10 | 5 | 18 | 14 |
| 12 | −0+0 | 10 | 5 | 21 | 28 |
| 13 | 0000 | 20 | 5 | 18 | 28 |
| 14 | 00++ | 20 | 5 | 21 | 42 |
| 15 | 0+0− | 20 | 10 | 18 | 14 |
| 16 | −+00 | 10 | 10 | 18 | 28 |
| 17 | +0−0 | 30 | 5 | 15 | 28 |
| 18 | 00+− | 20 | 5 | 21 | 14 |
| 19 | 0+0+ | 20 | 10 | 18 | 42 |
| 20 | 0++0 | 20 | 10 | 21 | 28 |
| 21 | 0−0− | 20 | 1 | 18 | 14 |
| 22 | −00+ | 10 | 5 | 18 | 42 |
| 23 | 0000 | 20 | 5 | 18 | 28 |
| 24 | 00−+ | 20 | 5 | 15 | 42 |
| 25 | 00−− | 20 | 5 | 15 | 14 |
| 26 | +00− | 30 | 5 | 18 | 14 |
| 27 | +00+ | 30 | 5 | 18 | 42 |

### <Step of Obtaining Experimental Values

The step (S2-2) of obtaining experimental values may be a step of performing experiments on the eco-friendly concrete in accordance with the experimental plan designed using the Box-Behnken matrix, and obtaining respective experimental values.

Specifically, the experimental values may be obtained through tests for evaluating the quality of the eco-friendly concrete.

For example, the experimental value may be the compressive strength (unit: MPa) of the eco-friendly concrete. The compressive strength values of eco-friendly concrete derived from experiments conducted under the 27 conditions shown in Table 5 may be as illustrated in Table 6 below.

TABLE 6

| | | | Foreign | | | |
|---|---|---|---|---|---|---|
| | | Cement | Substance | Slump | Curing | Compressive |
| | | Content | Content | Value | Time | Strength |
| No | Pattern | (wt. %) | (wt. %) | (cm) | (days) | (MPa) |
| 1 | 0+−0 | 20 | 10 | 15 | 28 | 22.8 |
| 2 | ++00 | 30 | 10 | 18 | 28 | 27.0 |
| 3 | 0−0+ | 20 | 1 | 18 | 42 | 33.7 |
| 4 | +−00 | 30 | 1 | 18 | 28 | 29.7 |
| 5 | 0−+0 | 20 | 1 | 21 | 28 | 25.4 |
| 6 | 0−−0 | 20 | 1 | 15 | 28 | 24.4 |
| 7 | 0000 | 20 | 5 | 18 | 28 | 25.5 |
| 8 | −−00 | 10 | 1 | 18 | 28 | 23.7 |
| 9 | −0−0 | 10 | 5 | 15 | 28 | 21.4 |
| 10 | +0+0 | 30 | 5 | 21 | 28 | 27.1 |
| 11 | −00− | 10 | 5 | 18 | 14 | 15.5 |
| 12 | −0+0 | 10 | 5 | 21 | 28 | 21.4 |
| 13 | 0000 | 20 | 5 | 18 | 28 | 25.5 |
| 14 | 00++ | 20 | 5 | 21 | 42 | 30.9 |
| 15 | 0+0− | 20 | 10 | 18 | 14 | 17.0 |
| 16 | −+00 | 10 | 10 | 18 | 28 | 21.0 |
| 17 | +0−0 | 30 | 5 | 15 | 28 | 27.3 |
| 18 | 00+− | 20 | 5 | 21 | 14 | 17.6 |
| 19 | 0+0+ | 20 | 10 | 18 | 42 | 31.0 |
| 20 | 0++0 | 20 | 10 | 21 | 28 | 22.8 |
| 21 | 0−0− | 20 | 1 | 18 | 14 | 19.7 |
| 22 | −00+ | 10 | 5 | 18 | 42 | 29.5 |
| 23 | 0000 | 20 | 5 | 18 | 28 | 25.5 |
| 24 | 00−+ | 20 | 5 | 15 | 42 | 29.9 |
| 25 | 00−− | 20 | 5 | 15 | 14 | 16.8 |
| 26 | +00− | 30 | 5 | 18 | 14 | 20.5 |
| 27 | +00+ | 30 | 5 | 18 | 42 | 35.5 |

### <Step of Deriving the Second-Order Regression Model>

The step (S2-3) of deriving the model is a step of deriving a second-order regression model using the experimental values obtained through step S2-2.

The second-order regression model may be expressed, for example, by the following Equation 1.

$$Y = {β}_{0} + {\sum }_{i = 1}^{k} {β}_{i} {X}_{i} + {\sum }_{i = 1}^{k} {β}_{ii} {X}_{i}^{2} + {\sum }_{i < j}^{k} {β}_{ij} {X}_{i} {X}_{j} + ε \qquad [ Equation 1 ]$$

In Equation 1, Y is a response (dependent) variable, βₒ is an intercept (constant), βᵢ is a first-order regression coefficient (main effect), βᵢ is a second-order regression coefficient (squared term, curvature effect), βᵢⱼ is an interaction regression coefficient (interaction effect), and Xᵢ and Xⱼ are independent variables (experimental factors normalized by coding). ¿ denotes the error term.

For example, a second-order regression model derived using the compressive strength values of eco-friendly concrete obtained under the 27 experimental conditions shown in Table 6 may be expressed as the following Equation 2.

$$Y = - 37.646 + 0.294 \cdot {X}_{1} - 0.303 \cdot {X}_{2} + 5. \cdot {X}_{3} + 0.491 \cdot {X}_{4} - 0.139 \cdot {X}_{3}^{2} \qquad [ Equation 2 ]$$

### <Step of Verifying the Reliability of the Second-Order Regression Model>

The step (S2-4) of verifying the reliability is a step of validating the second-order regression model derived in step S2-3. This may be done by comparing the experimental values obtained in step S2-2 with the predicted values calculated using the second-order regression model derived in step S2-3.

For example, the predicted compressive strength values of eco-friendly concrete corresponding to each condition listed in Table 6 may be calculated using the second-order regression model of Equation 2 and compared with the actual experimental values. Such comparison may be shown in Table 7 below.

TABLE 7

| | | Compressive Strength | Compressive Strength |
|---|---|---|---|
| No | Pattern | Experimental Value (MPa) | Predicted Value (MPa) |
| 1 | 0+0− | 22.8 | 22.9 |
| 2 | ++00 | 27.0 | 27.2 |
| 3 | 0−0+ | 33.7 | 33.8 |
| 4 | +−00 | 29.7 | 30.1 |
| 5 | 0−+0 | 25.4 | 25.2 |
| 6 | 0−−0 | 24.4 | 25.1 |
| 7 | 0000 | 25.5 | 26.0 |
| 8 | −−00 | 23.7 | 23.9 |
| 9 | −0−0 | 21.4 | 21.2 |
| 10 | +0+0 | 27.1 | 27.4 |
| 11 | −00− | 15.5 | 15.8 |
| 12 | −0+0 | 21.4 | 20.9 |
| 13 | 0000 | 25.5 | 26.6 |
| 14 | 00++ | 30.9 | 31.3 |
| 15 | 0+0− | 17.0 | 16.5 |
| 16 | −+00 | 21.0 | 20.8 |
| 17 | +0−0 | 27.3 | 26.9 |
| 18 | 00+− | 17.6 | 17.4 |
| 19 | 0+0+ | 31.0 | 30.6 |
| 20 | 0++0 | 22.8 | 22.4 |
| 21 | 0−0− | 19.7 | 20.2 |
| 22 | −00+ | 29.5 | 29.3 |
| 23 | 0000 | 25.5 | 25.5 |
| 24 | 00−+ | 29.9 | 30.7 |
| 25 | 00−− | 16.8 | 17.2 |
| 26 | +00− | 20.5 | 21.6 |
| 27 | +00+ | 35.5 | 35.0 |

The verification of the model reliability may be performed using analysis of variance (ANOVA) and a parity plot. Specifically, ANOVA is a statistical method used to test whether the differences between the means of two or more groups are statistically significant. It can be used to evaluate the effect size and significance of causal variables and may be performed using statistical analysis software such as SAS.

In addition, the parity plot is a 1:1 scatter plot in which the actual experimental values (Y-axis) are plotted against the predicted values from the second-order regression model (X-axis). This plot allows visual comparison between experimental and predicted values and can be used to analyze the reliability of the regression model.

In some embodiments, the method for manufacturing eco-friendly concrete may further include a step of analyzing the influence of each variable on the overall response using a Pareto chart, before the step (S2-5) of generating a 3D response surface plot and after the step (S2-4) of verifying model reliability.

The Pareto chart is a bar chart that visualizes the relative influence of each variable on the overall response, based on the coefficient analysis of the second-order regression model. It may be used to effectively identify the most influential variables among many.

### <Step of Generating 3D Response Surface Plot>

The step (S2-5) of generating a 3D response surface plot is a step of producing a three-dimensional response surface plot using the second-order regression model whose reliability has been verified in step S2-4. This step may include plotting contour surfaces of the response with respect to experimental factors acting as variables. Specifically, the 3D response surface plot may be a graphical representation that visualizes the influence of the interaction between pairs of experimental factors on the final response. It may be generated by pairing two experimental variables at a time and plotting the resulting interaction effects on the response.

### <Step of Deriving Optimal Mix Proportions of Eco-Friendly Concrete>

The step (S2-6) of deriving optimal mix proportions refers to a step of determining the optimal mix proportions of the eco-friendly concrete using the 3D response surface plot generated in step S2-5. Specifically, the influence of a pair of experimental factors on the final response (i.e., the quality or performance of the eco-friendly concrete) may be compared using the 3D response surface plot. Based on such comparison, the condition under which the predicted response (i.e., performance) reaches a maximum or minimum value-indicating the most desirable quality or performance of the eco-friendly concrete—may be identified as the optimal mix proportion.

### Eco-Friendly Concrete

The eco-friendly concrete according to one embodiment of the present disclosure may be manufactured by any one of the above-described manufacturing methods. Specifically, the eco-friendly concrete may be produced by the manufacturing method utilizing the above-described Response Surface Methodology (RSM), and may be designed based on optimal mix proportions derived using the Box-Behnken Design, which is based on a plurality of experimental factors considered in the manufacture of the concrete. Accordingly, the composition of the eco-friendly concrete may vary depending on the experimental factors to be considered during manufacturing, the intended application of the final product, and the desired material properties.

In order to reduce greenhouse gas emissions and the use of natural resources, the eco-friendly concrete may include eco-friendly materials obtained by selecting and processing construction waste, such as waste concrete, so that it can be recycled. Specifically, the eco-friendly concrete may include at least one of recycled aggregate and recycled soil.

In the present specification, the recycled aggregate may refer to artificial aggregate manufactured from crushed construction waste, which has a relatively large particle size and thus remains as residue without passing through screening equipment such as a vibrating screen.

In addition, the recycled soil may refer to artificial soil manufactured from crushed construction waste, which has a relatively small particle size and thus passes through screening equipment such as a vibrating screen.

The composition of the eco-friendly concrete is not particularly limited as long as it includes at least one of recycled aggregate and recycled soil in accordance with the optimal mix proportions derived by the above-described manufacturing method. For example, the eco-friendly concrete may include: 10 to 30 wt % of cement, 5 to 15 wt % of water, 30 to 50 wt % of recycled aggregate, 20 to 40 wt % of recycled soil, and 0.01 to 10 wt % of admixtures.

In some embodiments, the eco-friendly concrete may have a compressive strength of 25 MPa or more. Specifically, the compressive strength of the eco-friendly concrete may be 25 MPa or more, 30 MPa or more, or 45 MPa or more, and may be 100 MPa or less. The eco-friendly concrete is manufactured using construction waste instead of natural materials, and therefore not only exhibits excellent eco-friendly characteristics, but also may have compressive strength equal to or greater than that of conventional natural concrete.

The applications of the eco-friendly concrete are not particularly limited. For example, the eco-friendly concrete may be used in the manufacture of various secondary concrete products such as paving blocks, retaining walls or revetments, and drainage pipes.

By using the eco-friendly concrete, the actual recycling rate of construction waste can be improved, the depletion of natural aggregate resources can be mitigated, and both environmental and economic benefits such as reduction in production cost and enhancement of market competitiveness can be achieved simultaneously.

What is claimed is:

1. A method for manufacturing eco-friendly concrete using a response surface methodology (RSM), the method comprising:
determining a plurality of experimental factors to be considered in manufacturing the eco-friendly concrete (S1); and
deriving optimal mix proportions of the eco-friendly concrete using a Box-Behnken Design based on the experimental factors (S2).

2. The method of claim 1, wherein the eco-friendly concrete includes at least one of recycled aggregate and recycled soil.

3. The method of claim 1, wherein the experimental factors include at least three selected from the group consisting of: type of cement, cement content, composition of recycled aggregate, grade of recycled aggregate, content of recycled aggregate, composition of recycled soil, grade of recycled soil, content of recycled soil, foreign substance content, type of admixture, content of admixture, type of additional binder, content of additional binder, water-to-cement ratio, slump value, mixer capacity, curing method, curing time, curing condition, and specifications of the concrete product.

4. The method of claim 3, wherein the experimental factors include at least one of the grade of recycled aggregate and the grade of recycled soil, and
wherein the grades of the recycled aggregate and recycled soil are each classified into three levels according to their respective quality.

5. The method of claim 4, wherein the quality evaluation items include at least one selected from the group consisting of: absorption ratio, sludge content, moisture content, abrasion ratio, chloride content, density, and organic impurity content.

6. The method of claim 1, wherein the step (S2) of deriving the optimal mix proportions of the eco-friendly concrete comprises: designing a Box-Behnken matrix using the experimental factors as variables (S2-1); obtaining experimental values of the eco-friendly concrete according to an experimental plan designed by the Box-Behnken matrix (S2-2); deriving a second-order regression model using the experimental values (S2-3); verifying the reliability of the second-order regression model (S2-4); generating a 3D response surface plot using the second-order regression model (S2-5); and deriving the optimal mix proportions of the eco-friendly concrete using the 3D response surface plot (S2-6).

7. Eco-friendly concrete manufactured by the method according to claim 1.
